(19) United States
(12) Patent Application Publication
(10) Pub. No.: US 2014/0297666 A1
(43) Pub. Date: Oct. 2, 2014

(54) MANAGING EVENT DATA IN A DIARY

(71) Applicant: Taptron Limited, London (GB)

(72) Inventor: Gary Morris, Barnet Herts (GB)

(21) Appl. No.: 14/350,053

(22) PCT Filed: Oct. 3, 2012
(86) PCT No.: PCT/EP2012/069542

§ 371 Date: Apr. 4, 2014

(30) Foreign Application Priority Data
Oct. 4, 2011 (GB) 1117052.9

(51) Int. Cl. G06F 17/30

(52) U.S. Cl. CPC G06F 17/30442
USPC 707/754

(57) ABSTRACT

The invention relates to a computer system for managing event data comprising: a database storing event data relating to a plurality of events, each event associated with an event date; a handling function for receiving a request from a user terminal; the request including at least a user identifier, a date and a search refinement criteria; a filter function for returning event information corresponding to the date in the request, the filter function filtering event data based on characteristics associated with the user identifier, wherein the filter function is operable to filter events based on a history of events selected by a user making the request; and wherein the handler function is operable to supply the request to the filter function for accessing the database, the filter function operable to return events based on the user identifier and any search parameters supplied in the request, and to return events based on the user identifier where no search parameters are supplied in the request.

### FIELD OF THE INVENTION

The present invention relates to automated diary population.

### BACKGROUND

Electronic diaries have been available for many years. They allow a user to view on a display of their user device a diary which includes appointments, etc. for a user. Appointments are entered into an electronic diary in a number of different ways. A user can enter them manually by calling up a diary page and entering text in the appropriate time and date slot.

Alternatively, diaries can be shared across a number of users in a defined user group, such that appointments of one user can automatically populate the diary of another user within the group.

Appointments received by an email service can be transferred automatically into a diary by selecting an attachment within the email. Some applications allow specific invitations to be sent by email, whereupon a user upon receipt of such an invitation merely has to select the attachment and it populates his diary automatically. British Airways offer a facility which allows a user to select that a booked flight automatically populates their diary.

The word “diary” used herein implies an electronic store into which a user can enter appointments and which can present a view of these appointments to a user on a screen of a user device.

Calendars also exist, which display to a user a view of dates, times, etc. populated by appointments. Calendar usage has been extended recently by online sharing services such as Google calendars and the iCal format where calendar views of multiple diaries can be shared.

However, developments in calendar usage thus far have been confined to updating times and dates, adding notes and inviting participants. Apart from the limited possibilities to import specialist calendar entries, there has been limited development in population of a calendar other than by user input. Where a possibility does exist to import specialist entries, the user has to accept all of the data without limitation or refinement.

It is an aim of the present invention to provide a diary and calendar with facilities for automated population with substantially reduced user input.

It is a further aim to extend the type of data for populating a diary and calendar, without placing any additional burden on a user.

### SUMMARY

One aspect of the present invention provides a user device configured to automatically populate a user diary, the device comprising:
a processor configured to execute a program which generates a request identifying a date;
means for transmitting the request to an event database;
means for receiving from the event database event data corresponding to the selected date;
a user interface configured to present to a user event information based on the event data for the selected date so as to permit a user to select at least one event for populating the user diary, whereby selection of the event by the user automatically imports the event to the diary, by updating stored diary data.

Event data can be refined prior to populating the diary. Embodiments of the invention further provide API's to allow any website to provide event information in a format which can be imported directly into the user's diary.

The date in the request can be automatically determined as the present day, recognised by the user terminal or, alternatively, can be selected by a user using a calendar displayed to him.

The user device can take the form of any user terminal such as a personal computer, cell phone, tablet, personal entertainment device, games console or Smart mobile device.

The invention also provides a computer system including a user device and a database storing event data relating to a plurality of events and operable to receive a request from the user terminal and return event information corresponding to the request.

The database can be accessible to the device via a server system. The server system can be arranged to filter event data based on user preferences and/or characteristics prior to returning event information responsive to the request.

The server can be accessed by the user terminal via a network such as the Internet, with the user terminal having uploaded a web browser capable of delivering the functionality claimed herein. This is the case for a web-based application of the calendar service. Alternatively, a mobile version of the calendar service can be made available as an APP through a wireless portal contactable to the server system via a wireless network.

The invention also provides a computer system for managing event data comprising:
a database storing event data relating to a plurality of events, each event associated with an event date;
a handling function for receiving a request from a user terminal;
the request including at least a user identifier, a date and a search refinement criteria;
a filter function for returning event information corresponding to the date in the request, the filter function filtering event data based on characteristics associated with the user identifier, wherein the filter function is operable to filter events based on a history of events selected by a user making the request; and
wherein the handler function is operable to supply the request to the filter function for accessing the database, the filter function operable to return events based on the user identifier and any search parameters supplied in the request, and to return events based on the user identifier where no search parameters are supplied in the request.

A “history” button can be provided so that a user can select a date in the past to see if anything of interest has happened on that date.

According to one embodiment of the invention, the database includes events data associated with a category identifier and date identifier. Thus, the principle organisation of the event data can be by category, but associated with any particular date. This provides a first level of filter for displaying information to a user.

Filtering can be carried out by the server system. User preferences can be determined from a user via the user terminal. User characteristics can be obtained from a user profile used by the user in other networks, for example, social networks.

User characteristics can identify one or more user's network and other users “connected” in these networks, whereby the navigation history of the user and/or his connected users can be taken into account when filtering events to be recommended to the user.

Events can be searched by a user who can enter search parameters of the user terminal. In that case, the server system can receive the search parameters and return event data based on those search parameters. The search function provides a useful tool for a user separate or in addition to the filtering function.

One specific search parameter which can be used is a location parameter. To that end, the user device can include means for receiving a location indicator in the request which is supplied to the database. The location indicator can be derived automatically from the user terminal, for example, using a GPS location device at the user terminal, or can be entered by a user who can, for example, click on a country icon. To allow event data to be searched by location, event data can be held in the database in association with the location identifier. Multiple locations can be selected allowing the user to build/view an International itinerary. Public Holidays at a location can automatically update the calendar/diary.

Major national events such as Halloween/Valentines Day can automatically be updated into the calendar/diary.

Another search parameter can define an artist or venue, and the search can be configured to return a set of events grouped by a common criteria, such as artist. These can be displayed to a user in a “stack”, wherein a single event image is visible with a user selectable icon for selecting the display of all events in the group.

The invention further provides a computer system comprising:
a database storing event data relating to a plurality of events, each event associated with an event date;
a handling function for receiving a request from a user terminal;
the request including a user identifier and a date; and
a filter function for returning event information corresponding to the date in the request, the filter function filtering event data based on characteristics associated with the user identifier.

The invention further provides a server system for managing event data, the server system comprising:
a handler function for receiving a request from a user terminal, the request including a location identifier identifying a location of the user terminal;
a diary update function operable to update a user diary with a class of event data relating to the location identified in the location identifier.

The invention further provides a computer program product, comprising program code means which when executed on a computer at a user device implement the following steps:
generate a request identifying a date;
cause a request to be transmitted to an event database;
receive from the event database event data corresponding to the selected date;
present on a user interface event information based on the event data for the selected date so as to permit a user to select at least one event for populating a user diary, whereby selection of the event by the user automatically imports the event to the diary, by updating stored diary data.

The invention further provides a computer program product comprising program code means which when executed on a computer implement the following steps:
receive a request from a user terminal, the request including a user identifier and a date;
access an event database for event information associated with events; and
filter the event data based on characteristics associated with the user identifier to return event information corresponding to the date in the request after said filtering.

The invention further provides a computer program product comprising program code means which when executed on a computer implement the following steps:
receiving a diary update message from a user terminal, the diary update message including a user identifier and an event identifier identifying an event selected by a user at the user terminal; and
importing event data of the event identified by the event identifier into a personal diary associated with the user identified by the user identifier.

The invention further provides a computer program product in the form of an application programming interface, comprising program code arranged to receive information defining an event from an event source and to transform the event information into event data in a format suitable for loading into an event database.

The invention further provides a server system for updating a user diary, the system comprising:
a diary function operable to receive a diary update message identifying an event and to update the user diary with event data of the identified event; and
an update function configured to detect changes in event data stored in an event database and to generate a diary update message to automatically update the user diary with the changed event data.

The personal diary to be updated by the event data can be provided in the server system with the filtering function, or it can be a separate diary which receives an update message in a suitable format for updating the diary. For example, an existing calendar such as iCal can be updated with event data in accordance with an embodiment of the present invention.

Push notification/reminders can be provided of events listed in a personal diary or events that may be of interest to a user.

Clash event notifications can be provided such that a user gets a modal warning if attempting to add an event or diary event in the same time frame as an existing event

Embodiments of the invention can provide the ability to create an open diary which can be read widely; the writer being the author and the reader being the user. The user's diary is updated and populated with diary data from the author.

Embodiments of the invention can further provide the ability for the user to enter their own diary data to include a postcode; entry of such postcode allows the user to automatically view the event position on a map.

In addition to the architectural and structural search and filtering features for events discussed above, the following embodiments describe a number of ways of presenting event information to a user which simplifies management of a personal diary calendar for the user.

The invention also provides in a further aspect, a user device configured to automatically copulate a user diary, the device comprising:
a processor configured to execute a program which generates a request identifying a search parameter;
means for transmitting the request to an event database;
means for receiving from the event database event data corresponding to the selected search parameter, wherein the event data is received as a group of events sharing a common criteria defined by the search parameter;
a user interface configure to present to a user event information based on the event data wherein the group of events is displayed as a stack wherein a single event image is visible with a user selectable icon for selecting the display of event images of all of the events in the group.

The invention also provides in a further aspect, a computer system for managing event data comprising:
a database storing event data relating to a plurality of event, each event associated with an event date;
a recommendation and ranking function for supplying event information to a user terminal for display to a user;
a diary function operable to receive data from an event selected by a user and update a user's diary based on the event data;
wherein the recommendation and ranking function is operable to determine which events a user has selected to populate his diary and to locate at least one event in the database that is similar to events which the user has used to populate his diary whereby the at least one event can be supplied to the user as a recommendation.

For a better understanding of the present invention and to show how the same may be carried into effect reference will now be made to the accompanying drawings.

### BRIEF DESCRIPTION OF THE DRAWINGS

FIG. 1 is a schematic block diagram of a technical platform for implementing an electronic diary and calendar population service;

FIG. 2 is a screen shot of a home page of the service;

FIG. 3 shows expansion of the screen shot into various diary views;

FIGS. 4A-4C show the diary population service implemented on a mobile device to describe a search function of the service;

FIG. 5 is an architectural block diagram of a user terminal for implementing the service;

FIG. 6 is a schematic diagram showing message flow;

FIGS. 7A to 7C are illustrations of the user interface implementing a stack function; and

FIG. 8 shows the format of an event entry in the database.

### DETAILED DESCRIPTION OF PREFERRED EMBODIMENTS

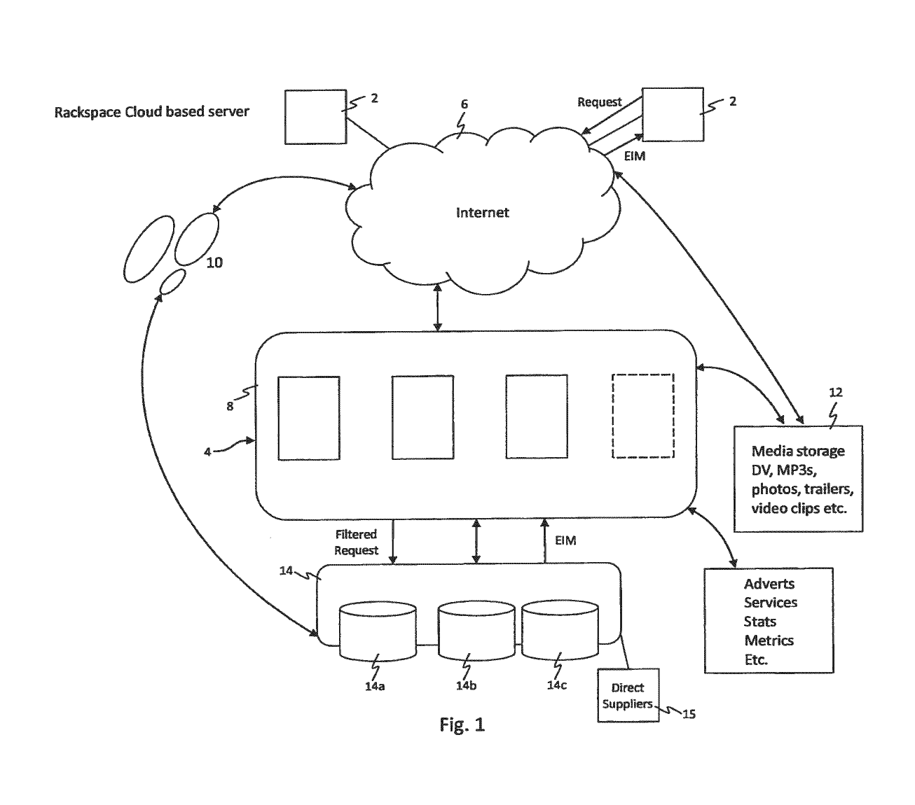

FIG. 1 is a schematic diagram of an architectural platform for supporting a calendar service. The platform of FIG. 1 is web-based. That is, the calendar service is available through standard browsers on a plurality of user terminals connected to the Internet. It will be appreciated that there will be a very large number of user terminals extending globally, but two are shown in FIG. 1 by way of example. The user terminals 2 are connected to a central server system 4 by way of a network such as the Internet 6. The server system can comprise a distributed collection of web servers 8, a system 10 for managing a plurality of web crawlers and a distributed media server 12. A database 14 is connected to the server system 4. The database can be managed by a distributed database server (for example, a sequel server) in the server system 4.

The web servers 8 serve primary front end web requests which are received via the Internet 6 from the user terminals 2. The database 14 serves the data storage and search needs of the population service, and is accessed by the web servers 8 and the system 10 managing the crawler services. In particular, the database 14 holds event data in a data format for allowing events to be displayed at the user terminals 2.

The function of the crawler services 10 is to crawl the Internet 6 to locate the sources of events and grab information about those events for supply to the database 14. Crawler services are known per se, and can run on a server instance and deposit fetched data into the database 14. In the present case, the crawlers are focussed on locating event data from event data sources. The crawler services extract information from websites providing events and convert the information into a data format for storage in the database. Event data is also supplied to the database through the Application Programming interfaces (API's) made available to event suppliers. The API's provide data to the database in the data format.

Another source of event data is an open diary having an author who enters his appointment in the diary—for example the author can be a celebrity.

The media server 12 can store and supply large, static content, when appropriate, such as images and videos. That is, the event data can include a pointer to media content, e.g. a video, to be displayed with the event information. For example, video content can play from sponsor's servers.

The event data is accessible through the instances of the population service running in browsers of the user terminals so as to automatically populate a personal user diary which is available to a user at his terminal.

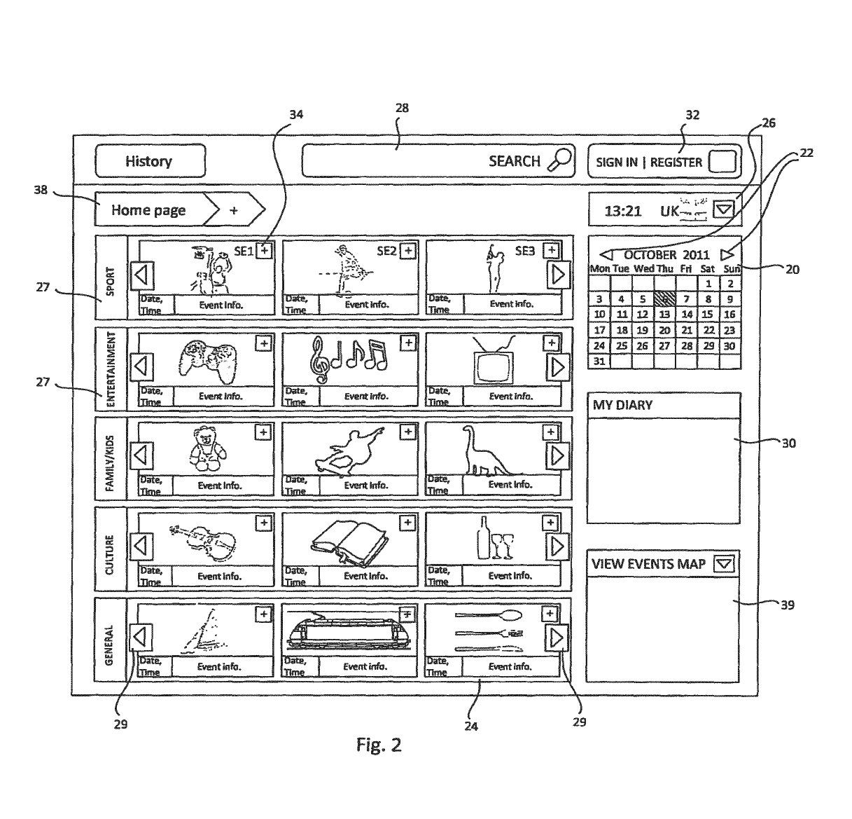

FIG. 2 shows a schematic diagram of a home page displayed to a user at his user terminal 2 when he enters the website address for the service using his web browser. Page shows a calendar 20 for the current month, displaying the current date highlighted. A user can change month by activating the arrows 22 by activating his user interface control, for example, keyboard, mouse and cursor, touch screen or in any other way. In the illustrated example, the date 6 Oct. 2011 is highlighted in the calendar 20. Located to the left of the calendar is an event display portion 24.

The event display portion can take a number of different display configurations as discussed more fully in the following, but on the home page illustrates a set of events in each of a number of different categories, for example, as shown in FIG. 2, sport, entertainment, family/kids, culture and general. In each category, a set of individual events is displayed which take place on the highlighted day 6 Oct. 2011. For example, in the category of sport, sport events SE1, SE2, SE3 are shown in adjacent display portions, each display portion having an image so that the user can readily identify the nature of the sport event, a date portion with the date of the event and a text portion describing details about the event. Event information displayed in other categories has a similar format. The event information which is displayed to a user pertains to the date selected by the user in the calendar 20. When the home page is launched, the display defaults to the current date, which is highlighted. However, a user can change the date with his user interface control (user input device) and when he selects a different date, event information for that date is automatically displayed to him.

This is achieved in the following way. When the user selects a date on the calendar 20, a request is transmitted from the user terminal 2 via the Internet 6 to the server system 8 for event information related to that date. The event information for the relevant date is retrieved by the server system 8 from the database 14, which holds event data which has been uploaded to the database 14. The relevant event information is returned in the form of an event information message (EIM) via the server system 8 and the Internet 6 to the user terminal 2 that requested that particular date. In one embodiment, on the user display the selected date is shown in yellow highlight, while the current day is shown in a grey highlight. As the user navigates away from the current month using the arrows 22, a memory retains data identifying the current day such that the user can automatically recover current day information.

The event information can be retrieved from one or more database servers. Three database servers 14a, 14b, 14c are shown in FIG. 1. The database server 14a holds information about events in the United Kingdom, the database server 14b holds information about events in the USA and the database server 14c holds information about events in Europe. It will be appreciated that the principle can be extended to any number of geographical locations, organised by country or in any other way. The database which returns the event information for display to a user can be selected in a number of different ways. The user interface illustrated in FIG. 2 shows a country flag 26 associated with a drop-down menu from which a user can select one or more of a number of different countries, but only selecting one country at a time. When a country has been selected, the request which is transmitted from the user terminal 2 contains information about that country which redirects the request to the correct country specific domain. Although illustrated as separate servers, it will be appreciated that any implementation of country specific domain is possible.

Alternatively, automatic location of the user can be accomplished and this location information is incorporated into the request from the user terminal each time a request is transmitted from that user terminal. The location can be determines automatically by using a built-in GPS or other geo location function in the web browser of the user terminal, or by considering IP address information or using cookies or in any other way. If the user location is provided automatically, a function can be provided to a user to allow him to override it and choose another location.

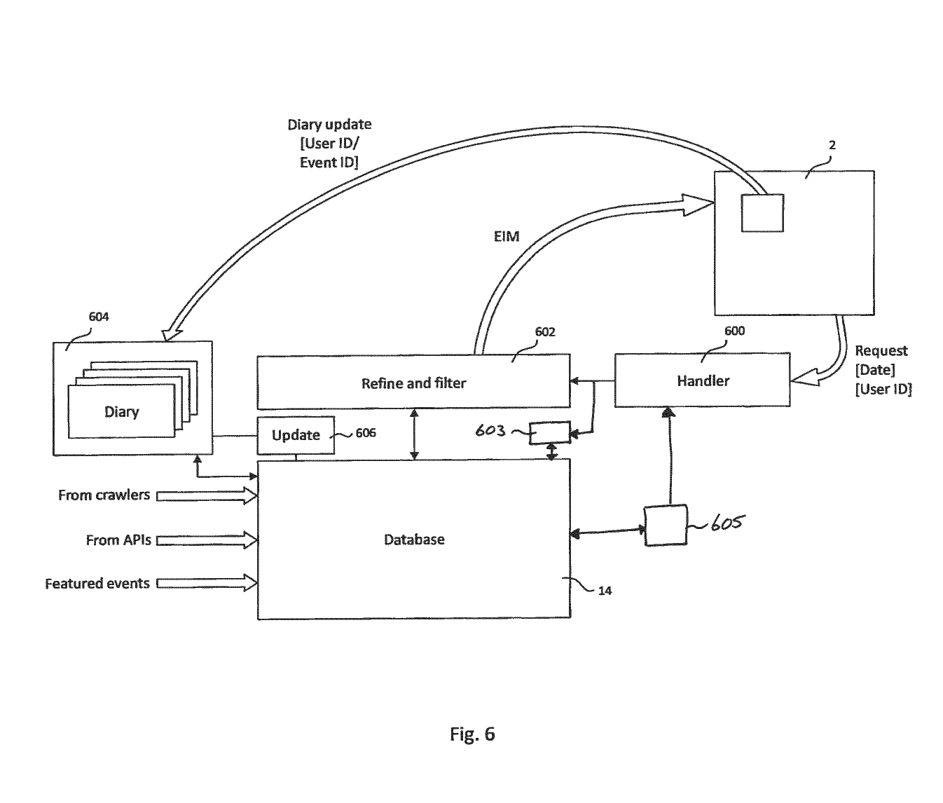

The population service incorporates a search tool 603 (FIG. 6) which provides a text box 28 to a user. A user can search by keyword, word or phrase to locate events of interest. Advance search options are also possible, for example, if a user wants to view pop concerts for five days from 21 October, then in advance they can enter words, categories and dates ahead of that date.

If a user is interested only in one of the categories displayed to him, he can select that category, for example, by using a mouse and cursor to click on the category tab 27 associated with the event whereupon all events displayed to the user are in the selected category. Scroll arrows 29 are provided in each category to allow a user to scroll within the category. A plurality of events are available from the database for each date in each category, not all of which may be able to be shown on the display at the same time.

The display provides an event map 39 which shows the location of an event on a display when the user selects the event, for example by clicking on it.

Event information supplied to a user can be refined by characteristics associated with the user. These can be shared with a user identifier at the server system, along with user preferences and user event selection history.

One such characteristic can be the name of an author of an open diary, for example a celebrity. In that case, the celebrity's appointments/events are shown to the user.

Thus, filtered and organised events can be displayed to a user in association with his calendar.

The automated diary and calendar population function will now be described. In FIG. 2, reference numeral 30 illustrates a user diary. In order to see or access their diary, a user must register or be signed in. This provides a user identifier associated with the user. A sign-in and registration box 32 is provided to the user for this purpose. If a user sees an event that they would like to attend, they can add it to their diary simply by actuating an add button 34 which is associated with each event. It will be appreciated that the add button could take any form and could in fact be omitted in place of a function where a user could actuate the event information itself displayed to the user, for example, by actuating the image, date portion or text portion or the entire footfall of the event image.

Following a search for a particular category or micro category, a user may determine that all events displayed to him as a result of the search are relevant and can select an “add all” function to add them all into his diary.

An automatic update feature can be provided for selection by a user. According to this feature, a class of events can be preselected by a user which automatically populate the user diary without the user having to take any action. For example, an open (e.g. celebrity) diary can be selected by a user to automatically populate their personal diary with celebrity events.

When a user has selected an event to populate his diary, a marker appears on that date in the calendar 20 to indicate that the user has an event on that date.

A user can also input to the diary personal dates with information and explanation that the user can provide. These can also be marked in the calendar.

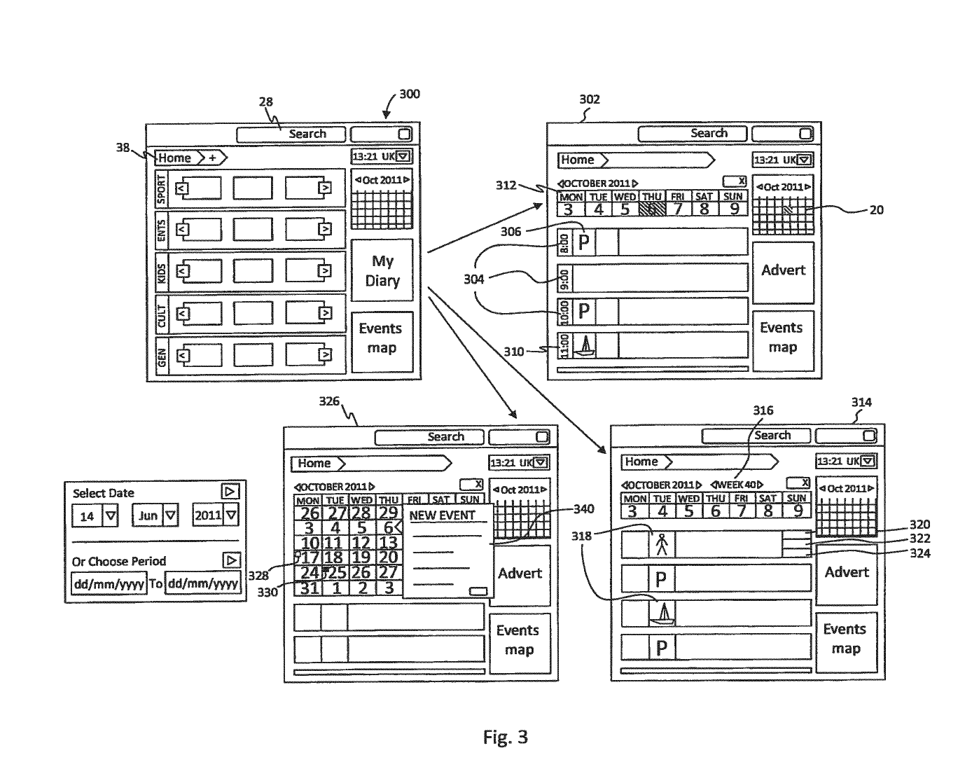

FIG. 3 illustrates different views of the calendar and diary function provided by the calendar service. Reference numeral 300 denotes the home page which has been described in more detail already with respect to FIG. 2. In addition to the search box 28, events can be displayed to a user in a number of different formats. The different formats can be selected by selecting different modes using the bar 38. Reference numeral 302 denotes a selection of day mode using the bar 38. In day mode, the events entered into the user diary for that day are shown. The diary is divided into time slices 304 with each time slide being populated by an event or not depending on the selections which have been made by the user previously. Events can be personal, and can be represented by a specific personal icon 306 or they can be stored events from the event database 14, for example event 310. Events from the database can be recognised by carrying an image representative for the event as in the image portion described above with reference to FIG. 2.

In day mode, it is possible to activate (for example, by single clicking) any day which is illustrated on the day bar 312 to make an entry into the diary on that activated date. An entry portal is opened which is described later.

The time slices can be any size but typically they may be one hour slots. It is likely that a user will not have an event every hour.

A user can activate a time slice, for example, by clicking, to enter an event into that time slice, by opening an entry portal.

The calendar 20 is visible in day mode and can be used to look at dates without changing the diary view. If a user activates a date in the calendar, the diary view will update to that date.

Reference numeral 314 denotes the diary view presented to a user when week mode has been selected at bar 38. In week mode, the week number in the year is displayed as shown at 316. As with the day mode, activating any day which is visible in that week allows an entry to be made into the diary on that activated date.

Furthermore, as with the day mode, events in the event database can be easily recognised by the image associated with the event as in the image portion. This is denoted by reference numeral 318 for two of the events. Personal events are recognisable by the personal icon 306. It is noted that users can personalise their personal icon for each event by uploading an image or photo to replace the generic icon.

Each event is associated with a set of functions 320 to 324. Although not described with reference to day mode (and month mode which follows), these functions are available in all modes. The share mode 320 allows a user to share the event with others, for example, by emailing it.

The remove function 322 allows a user to delete the event from the diary. The edit function 324 allows a user to alter aspects of the event, provided that it is a personal event. It is noted that a limited edit function is available for events from the event database so that a user can edit all information but the edited information is only visible to them. They cannot share the edited event. This is done in case they wish to add time handles or if crawled data in the database is incomplete. Reference numeral 326 denotes the diary view in month mode as selected by bar 38. In the monthly mode, a single month is shown in full, with events marked against days of the month. An event from the event database can be marked with a dot of a first colour, for example, yellow and personal events can be marked with a different colour dot, for example, grey. By way of example, a personal mark 328 is shown against 17 October, and a database event mark 330 is shown against 25 October.

The monthly view 326 shows a modal entry window 340 which can be used to enter a new personal event. The modal entry window 340 can be provided to a user on actuation of a selected date in any of the monthly, weekly or day views. The modal entry window 340 includes a plurality of fields including:
Location, time of event, diary status, alarm, invitees, attachments, URL and note.

By entering appropriate details into these fields, a user can add a personal event to the diary. A postcode field can be provided. If a postcode is entered, the location of the event is shown on the events map 39.

The fields for entering the personal event can match the fields for event data in the database. Data entered into a personal event entry window can be supplied to the search function 603 to allow a search to be carried out using that data.

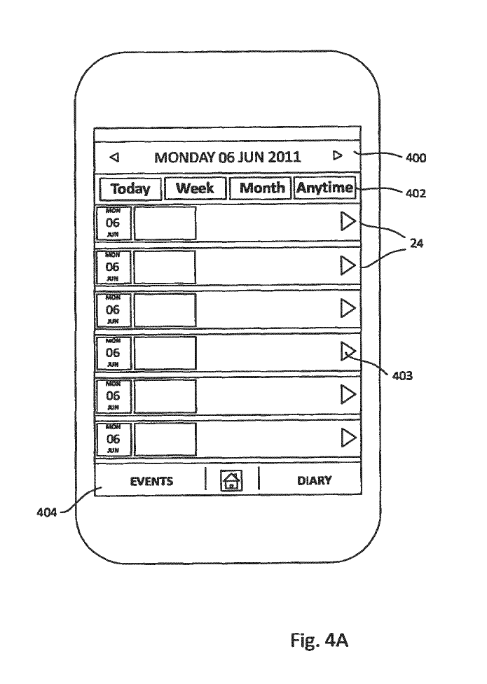

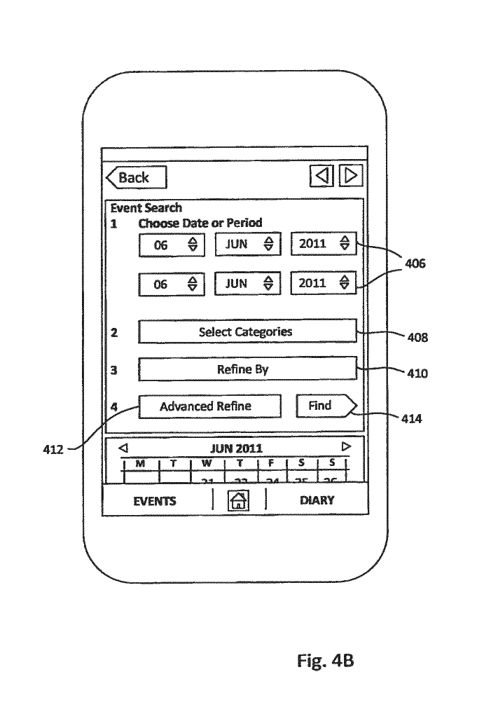

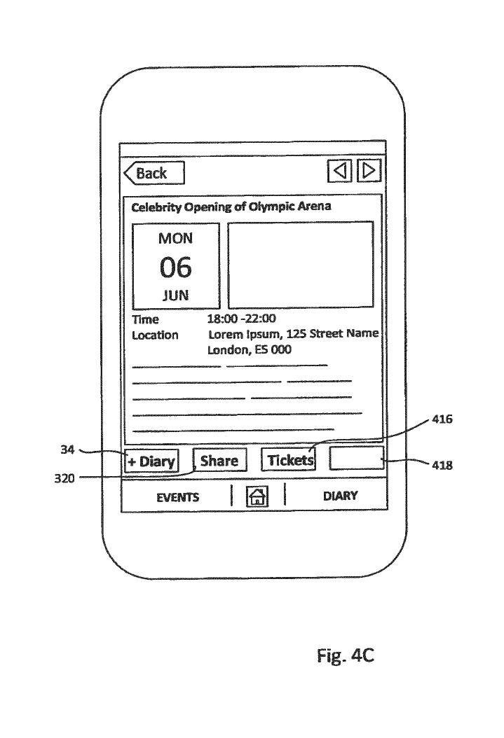

Reference will now be made to FIGS. 4A to 4C to describe the search function for database events in more detail. FIGS. 4A to 4C illustrate a user interface on a user terminal in the form of a mobile device such as a smart phone. It will readily be appreciated that the concepts described above with respect to a web-based user terminal can be applied on a mobile device implemented as an APP, while the search concepts which are about to be discussed with reference to the mobile device can similarly be applied to any type of user terminal. The particular display configurations are given here by way of example only and are not intended to be limiting.

FIG. 4A illustrates the home page of an event service suitable for a mobile device. Reference numerals are used to denote the same items as on the home page illustrated in FIG. 2, although the display configuration is different. The current date 400 is displayed at the top of the screen. A user has the ability to flick forward and backward day by day using arrows on the right and left of the date 400. Four quick searches are made available by reference numeral 402. These searches include “what's on today”, “what's on this week”, and “what's on this month”. Each search, when activated, shows a set of events in display portions 24 for that day, week or month which can be scrolled through. The fourth quick search is activated through the “anytime” button. This button accesses an event search page. This event search page can also be accessed from an events button 404. The event search page is shown in more detail in FIG. 4B. A date or period can be entered by using the date fields 406. A select categories field 408 allows a user to access a categories list.

A “refine by” field 410 allows a search to be refined in a number of different ways, for example, by city within the UK, by country, by most popular, by top ten, by category or by recently added.

An optional advanced refine field 412 allows further refinements of the search, for example, by just added, alphabetical event A-Z, alphabetical event Z-A, date nearest, date furthest, category, randomised, UK location (top twenty cities), international (twenty countries), most popular venue indoor, venue outdoor.

A find button 414 instigates the search by sending a request to the server system 8 and consequently the database 14 for events which match the search criteria. These events are returned to the device for display to a user.

FIG. 4C illustrates a display page which can be made visible to a user by actuating a detailed page icon 403 which is associated with each event, and illustrated in FIG. 4A. The display page shows details of a single event, with the image portion, date portion and text portion as already described with reference to FIG. 2. A share function 320 associated with the event allows the event to be shared with friends. The event has an add button 34 for adding the event to a user's diary. When the add button is activated, the event automatically populates the user diary. A tickets function 416 is highlighted if tickets to the displayed event are available. The ticket function 416 can display contact details for ticket sellers or provide a direct link to an affiliate ticket seller's page. A category box 418 allows a user to see a list page of other related events within the same category.

One issue which can arise with display of information to a user is that too much information or the wrong type of information is displayed to a user, which can be off-putting and difficult for a user to manipulate. This can be managed in a number of different ways.

According to one option, a user will be provided with a mechanism for inputting a preference as to how their display should be populated with event information. For example, they could prefer that they only receive events for times after 5:00 in the afternoon or weekends, for example. Alternatively, they could express a preference for events to be filtered on any of the refine options in the search (for example, as described above with reference to FIG. 4B).

Whether or not a user expresses a preference, events can be filtered by the server system 8 which extracts events from the database for supply to the user terminals.

The system can filter for events that happen in the future, which match user preferences with categories chosen and search options by time slot, and displayed by day, week or month. The server system 8 could be operable to extract information from social networking sites associated with the user to determine a user profile, such that events appropriate to that user are displayed to them.

As one specific example of this, age range identification would allow content and event filtering, while geo location services could be used to find current location, especially for use with mobile devices.

The database 14 of events is organised by category. In addition to crawlers 10 supplying events to the database, scrapers could also be used or the database could have direct feeds (through API's) from explicit suppliers such as aggregators and ticketing service suppliers. These are denoted by block 15 in FIG. 1. Open diaries can also be provided.

Location services support zip code and post code for an “around me” style of event reporting. That is, each event in the database is associated with a location identifier which can be used as a search tag if location information is supplied from a user terminal in the search. The location identifier can also be used to display the location of the event on the event map 39.

It will be appreciated that each of the search parameters described above with reference to FIG. 4B can be implemented as a tab against event data for a particular event in the database.

Users can create a “most popular” listed ranking of events so that less popular events will be aged and eventually culled based on age.

A possibility exists to allow sponsored events to be hardwired to appear at the top of listings. That is, a certain type of event (sponsored) will be marked in the database with a tab which overrides other search criteria but which still nevertheless falls within the user search parameters of date and category.

After a user has used the event service for some while, it is possible to determine which events the user has used to populate his diary, and thus determine the set of events that the user likes. Then, a group of events can be located in the database that is similar to the set of events known to be liked by the user and these events can be ranked and recommended to the user. In that case, it would not be necessary for a user to enter search criteria—instead when he opened his calendar at a certain day the group of events similar to those he has liked in the past, duly ranked would appear to him. The recommendation and ranking function (605 in FIG. 6) is carried out by an algorithm executed at the server system which runs on the data in the database.

The recommendation function will now be described in more detail.

The recommendation function is based on a hybrid method combining collaborative and content-based filtering methods.

### Collaborative Filtering

The Collaborative filtering used is a variant of item-to-item collaborative filtering to recommend based on user history. Information is retained (for example a store of the diary function 604) about all events the user has added to diary and those he visited if he has not added to diary enough events.

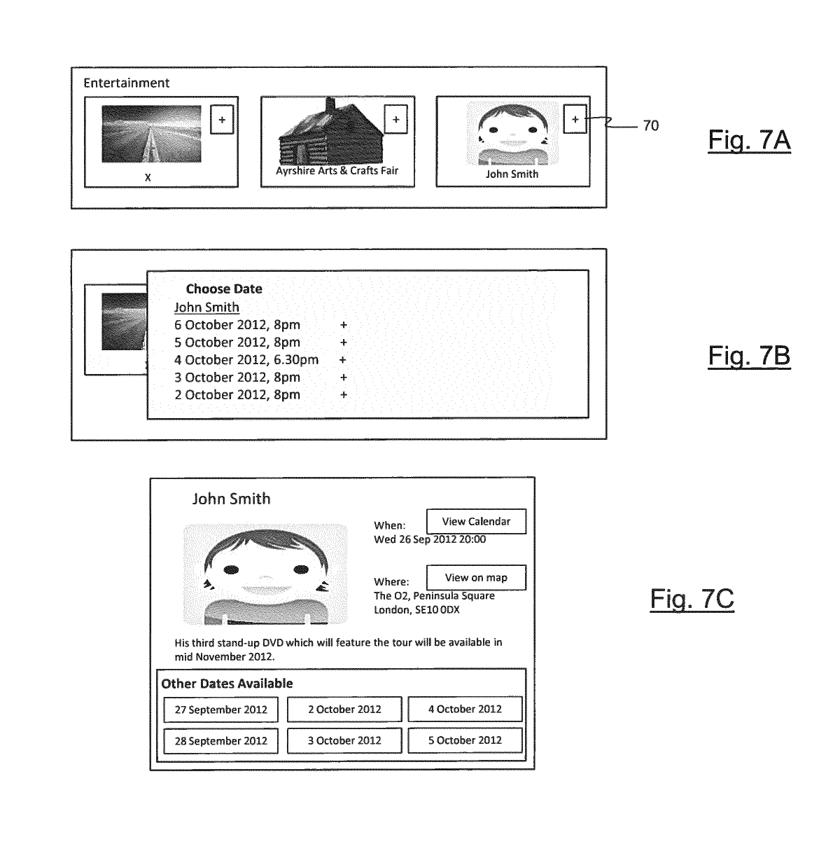

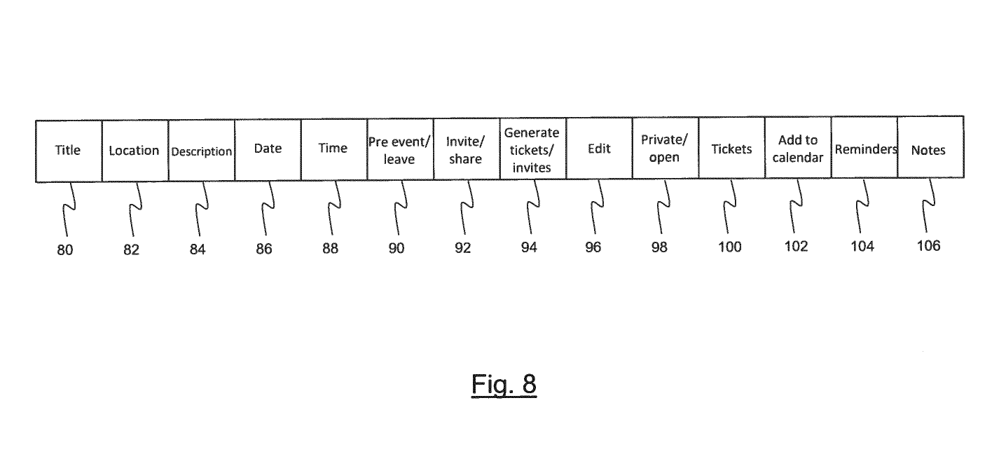

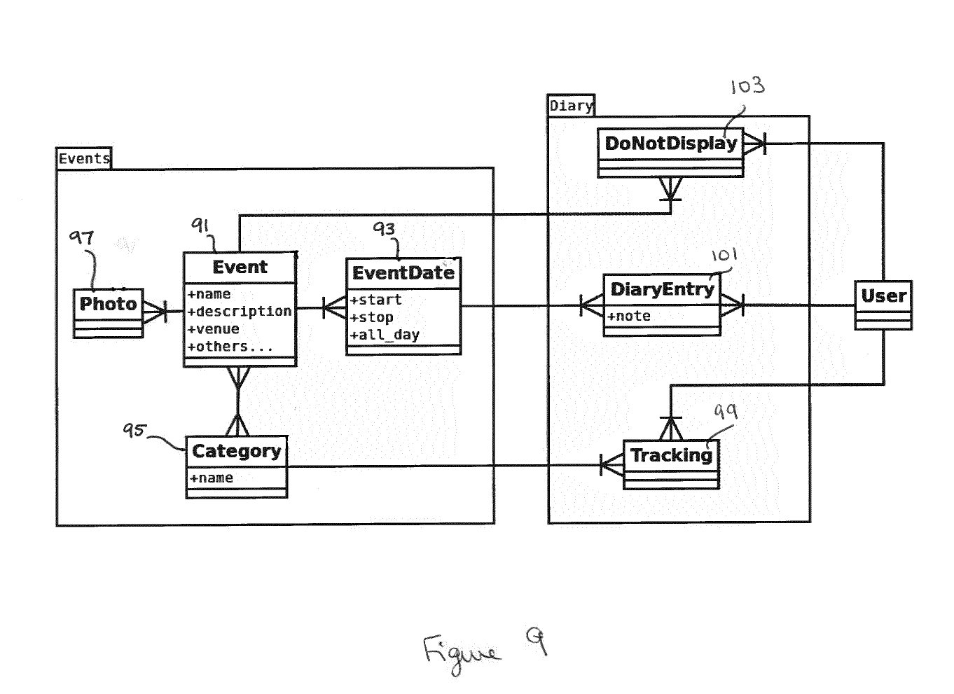

FIG. 8 illustrates the format of an event entry in the event database 14, in accordance with the embodiment. It is not necessary for each event to have all of these fields populated, but they are all available if there is data to populate them. However, certain fields are a prerequisite for efficient searching and/or recommendation features. The event entry comprises a title field 80 which holds the title of the event—this could include, for example, an artist name such as John Smith or an event title such as Ayrshire Arts & Crafts Fair (see FIG. 7A). Reference numeral 82 denotes a location field which holds a location of the event. Reference numeral 106 denotes a notes field which includes any notes a user has made concerning the event. Reference numeral 84 denotes an event description field. When searching for similar events, as described below, it is fields 80, 82, 84, 86, 88 and 106 which are taken into account.

The event entry also includes a date field 86, a time field 88, a pre-event time/leave time field 90. The event entry also includes a invite/share field 92 which defines how the event is to be shared by the user, for example, with other users connected to the user in social networks. The event entry includes a generate tickets/invites field 94, an edit field 96 and a field 98 which indicates the status of the event whether private or open when it is to be incorporated into a shared calendar. The event entry includes a ticket field 100, an add to calendar field 102 and a reminders field 104.

The add to calendar field 102 is updated when a user has selected the event so that it populates the user diary.

In another embodiment, the event data is separated from event date data in accordance with the following:

### Event

name
description
venue
url—url it was grabbed
slug
geohash (latitude, longitude in fact)
featured_flag
affiliate_flag
ranking—boosting ranking
click_ranking—ranking counted from clicks and boost
hidden_flag
clicks—how many times events was visited
owner—if it is users' event—points to user
private—if event is publicly visible
all different image size fields+link to original image
tags—categories of event
crawler—crawler that grabbed this event

### Event Date:

event—points to event
start—date and time
end—date and time
all_day—if event is all day event
hidden_flag
day_of_week
day_of_month
month_of_year

Event to event similarity is an expensive computation and is computed offline in the way described in the following pseudocode:

```
function count_and_store_similarity(event, another_event) {
    in_one_diary = number_of_events_in_one_diary(event, another_event)
      return
in_one_diary/ (number_of_diaries (event) *number_of_diaries(another_event)
}
function count_similarities(all_events) {
    for event in all_events {
        diary_entries = all_diary_entries_for_event(event)
        similar_events = list( )
        for entry in diary_entries {
                    similar_events.append(get_events_in_diary_with_entry(entry))
        }
        for another_event in all_events {
            if another_event in similar_events {
                count_and_store_similarity(event, another_event)
            }
        }
    }
}
```

This is computed for all events added to the database compared with events already added into user diaries.

For all events, a huge matrix of event to event similarities is the result of this process. Storing only similarities of events with some minimal reasonable similarity makes this matrix smaller and faster to access. Thus, a matrix of events having a minimal reasonable similarity is stored.

Those offline computed similarities in the matrix can be later easily accessed to get event recommendations for a specific user based on the most similar events to those in the user diary for the specific user or the diaries of users to who he is connected in one or more of his social networks. In pseudocode:

```
function get_recommended_events (user) {
    events_from_diary + get_events_from_diary(user)
    recommended = get_most_similar_events (events_from_diary)
    return recommended
}
```

There are two places where recommendations are used.

### Index Page and Category Pages

The first place is index page (shown in FIG. 2) and all category views where recommended events are always appearing at the beginning of each category.

Those events are only based on collaborative filtering method with fixed limit of minimal similarity, so the accuracy of those recommendations is quite high.

### Event Details

At event detail pages (see for example FIG. 4A) “You may also like” consist of event from collaborative method (once again with fixed but lower than on category pages minimal similarity) at the beginning followed by events content-similar up to fixed number of events.

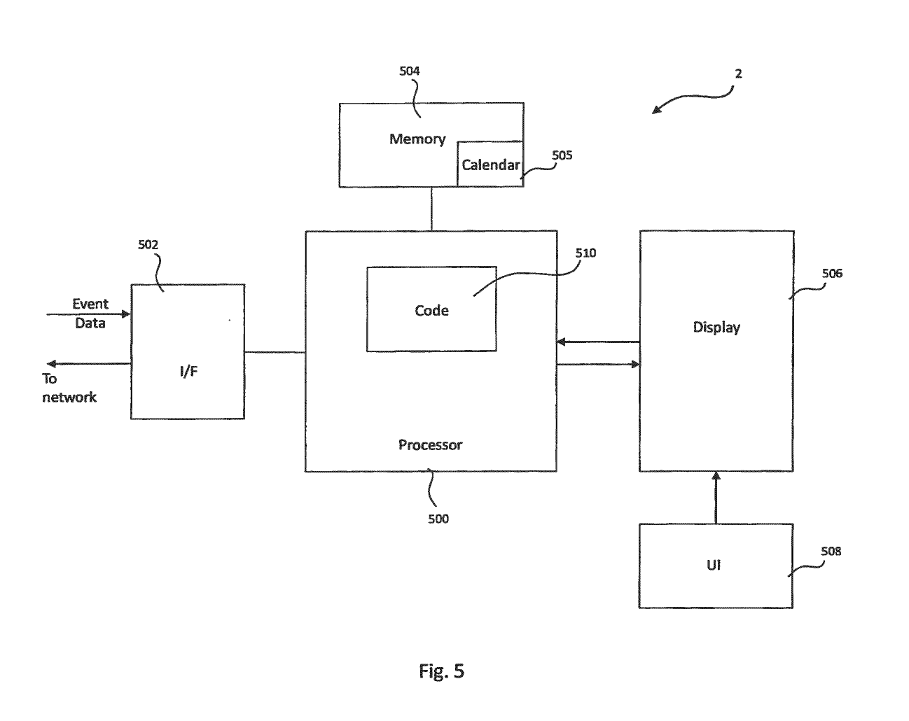

FIG. 5 is a schematic diagram of hardware at a terminal 2. Each user terminal 2 may comprise a processor 500 connected to a network interface 502, a memory 504 and a display 506. The display is associated with the user interface 508 which has an input device such as discussed before e.g a keyboard and/or mouse and cursor and/or touch screen. Processor 500 is arranged to execute code portions 510 which can be downloaded from the memory 504. The code portions implement the various event display functions described above by acting on instructions received from a user via UI 508 and returning relevant information presentation instructions to the display 506. In this way, the code portions in conjunction with the UI elements of the display constitute means for implementing various functions at the user terminal.

The memory 504 also provides a store which can provide a cache for the personal user diary.

When an event is selected, event data automatically updates the diary data. The diary data for each user is held at the server system.

The presentation information instructions which are supplied from the processor 500 to the display 506 include event data which is supplied from the event database 14 via the server system 8 through the network interface 502. It is assumed that event data incoming to the user terminal 2 via the network interface 502 has already been filtered to a significant extent such that management of the event information to be displayed can then be handled by the local processor 500 at the user terminal. It will be appreciated that the server system 8 and database 14 also include processors running code portions to implement various means which carry out their respective functions.

FIG. 6 shows the message flow in more detail. The server system 8 provides a handler function 600, a refine and filter function 602 and a diary function 604. A request transmitted from the user terminal is received by the handler function 600. As described above, the request includes the date, which is either the default date or the date selected by the user. In addition, the request includes a user identifier which identifies a user logged into the user terminal 2. The request can also include search parameters, etc. as described above. The handler function 600 supplies the request to the filter function 602 which accesses the database 14 to retrieve event data dependent on the date and the user identifier, and on any other search criteria which have been supplied with the request. Importantly, even if the user does not specifically enter any search criteria or other event-related information (such as categories), the filter function 602 nevertheless responds to the request by returning events which are refined for that user based on the user identifier. Event data for these set of events determined to be interesting to the user is returned in the event information message EIM to the user terminal 2.

When the user makes a selection of an event, a diary update message is transmitted from the user terminal 2 to the diary function 604 at the server system 8. The diary update message includes at least a user identifier and an event identifier. The user identifier allocates the update to the appropriate diary for that user. It will be appreciated that the diary function 604 runs a number of personal diaries associated with respective users. The event identifier in the diary update message allows the event data associated with that event to populate the diary for that user, as described earlier. The diary function 604 thus includes a store which holds data populating the diary. When the user uses an entry portal to enter a personal appointment, a similar diary update message is transmitted from the user terminal 2 to the diary function 604 to update the diary.

As mentioned above, personal user diary data can be also be cached locally in the memory 504 in addition to being held at the central server system 8 in the diary function 604.

As already explained above, the database 14 receives event data from crawler services 10, from API's associated with direct suppliers and possibly from a set of featured events which can be identified by the user of the server system or by other appointed users.

The database is updated with event data periodically or in real time. If event data for an event changes, the new event data is associated with the event identifier and automatically updates the diaries of users who had that event in their diary. This is carried out by the update function 606.

The update function 606 also allows a user to preselect a class of events (e.g. an open diary for a celebrity) which automatically updates their personal diary whenever a new event/appointment is added to the class of events.

The user interface can be arranged to enable a user to enter a search parameter and to receive the event data as a group of events sharing a common criteria defined by the search parameter. In that case, the user interface is configured to display the group as a stack wherein a single event image is visible with a user selectable icon for selecting the display of all the events in the group. FIG. 7A illustrates a user interface where the event display image on the right hand side is such a “stack”. This is the result of entering an artist name, for example, John Smith, into the text box 28 which allows entry of a keyword for a search. The event image has a user selectable icon 70 which, when selected, indicates a plurality of dates on which the artist is performing (see FIG. 7B).

Alternatively, by clicking on the image portion itself, a screen such as that of FIG. 7B is displayed, showing the image with other dates available.

This is a particularly efficient mechanism for providing event data to a user which avoids cluttering the user display. In FIGS. 7A and 7C, reference numeral 72 denotes a field in which the artist name can be displayed.

FIG. 9 is a schematic diagram illustrating the cooperation between the event function and diary function in more detail. FIG. 9 illustrates as part of the event function, event data 91 including name, description, venue, etc., as described earlier, event date data 93, category data 95 and image data (photo 97). The event data, event date data, category date and image data can each be implemented as a functional software component capable of interacting with each other and with components in the diary function. The diary function provides a tracking component 98, a diary entry component 101, and do not display component 103 all capable of interfacing with a user.

In the present description, embodiments of the invention are described offering a number of improvements and advantages in the field of event data and diary/calendar population.

Embodiments provide a user device or devices all of which update if accessed under a single login, configured to automatically aggregate event information (an event being something a person may attend or observe or take-part in) and populate a user diary or be present within the diary/calendar database allowing the user to add a single or multiple events into the calendar, the device comprising:
a processor configured to execute a program which generates a request identifying a date and/or dates, and/or location and or keyword such as artist or venue or interest or category;
means for transmitting the request to an event database;
means for receiving from the event database event data corresponding to the selected date and/or dates, and/or location and or keyword such as artist or venue or interest or category;
a user interface configured to present to a user event information based on the event data and/or dates, and/or location and or keyword such as artist or venue or interest or category for the selected date or dates so as to permit a user to select at least one event for populating the user diary and or adding it to their social network sites, and or sharing the event with their contacts, whereby selection of the event by the user automatically imports the event to the diary/calendar, by updating stored diary data.

By virtue of populating the diary the user now also gets a map showing the event location, travel updates to the zip/postcode area, weather updates if within forecasting range of the area selected, and the ability to find nearby restaurants and/or bars and/or other places of interest. All such data can be shared. The user can also select the map and choose to look anywhere in the world for similar or any event. The user can select and save keywords to preferences allowing the database to push notify the user of similar events being posted into the database. The user can select to ignore or add the event directly into the calendar. The user is warned by virtue of a popup should adding an event clash with another calendar entry.

To select a date, the user taps any date to view events on that date. For a date range the user taps a date, holds down and scrolls to the end date before releasing their mouse button.

Each ‘signed in’ user is presented with a bespoke set of events based on algorithms which track the users navigation and other users tracked navigation whereby the same event has been viewed and the probability of navigating forward is anticipated based on where the majority of other users go. This means the user is always looking at relevant events that they are likely to like or want to know about. This unique event display, made for each individual user, can be refined further by virtue of personal preferences (nearest within a defined perimeter . . . furthest from current location or any input zip/postcode . . . free . . . most to least expensive and vice versa . . . date soonest to furthest and vice versa . . . scale of event . . . time of day, soonest to furthest and vice versa . . . alphabetical a-z or z-a . . . by venue . . . ticketed . . . by artist . . . most popular . . . random.

Categories also comprises sub categorisation. The categorisation works in tandem with keywords with the event detail so as to automatically rank listings so as to be most relevant to the user. The user themselves can determine or input keywords, which help rank an event higher for them, but also the calendar algorithm determines ranking a category higher based on keywords which may repeatedly appear in detail about the event during the users navigation history. The unique structure of code is able to stack similar events into a single event window so that the user is not deluged with a repeat artist playing multiple dates for example. The stacking displays one artist with text to indicate that multiple dates are selectable. The user interface further allows the user to see all dates by selecting a single ‘+’ button within the event box. This is presented in a modal window.

Algorithms will also present similar events in multiple categories within a ‘you may also like’ section beneath the main category on display.

The calendar recognises the user's location and can push/display events to their device for that location. The user is able to switch to any one of multiple post/zip codes at any time through the filter, and layer results. For example, if a user is in location A and selects to view events in that location, then selects one event, the system will indicate if that event is also in other locations, whereby the user can display those events. Or a user can input any other location and select ‘similar events’ to find matching events in other locations.

Geo-location can be selected in user preferences allowing the user to, by default, view nearest events. A selectable icon on the user interface allows the user to (i) view a world map (ii) drag and select any country, town, or place, always being presented with ‘popular’ event markers on the map, wherever they look. The user may also input single or multiple zip/postcodes and view events by filter, in all locations simultaneously. Entry of a post/zipcode automatically creates a map within the calendar, so that the user can view their event and see its location in respect of their location.

The location device which automatically determines the position of a user and generates the location indicator works in alignment to the user's personalised settings and algorithms to display relevant events which the user is more likely to want to view. In addition the user can enter other addresses within the maps and get directions from A to B. Traffic updates according to the route are automatically fed into the user's diary; if the user selects travel by public transport then the diary/calendar is automatically updated with any such delays.

As an alternative to an activatable icon for selecting the event, the entire event footfall can be used for selecting the event. Also the event can be added directly to the calendar from the image portion.

The user interface is configured to display to a user means for selecting different diary views, the different diary views including day mode, week mode and month mode, derived from the stored diary data. Each view can be preferenced by a user, meaning they can select which day of the week their week-view starts . . . the hours displayed in day-view . . . whether month view is the next 31 days or the current month. The user enters their event and/or meeting into predetermined fields of the modal window allowing their event to display in the same way as a commercial event.

Personal events can be marked in the diary views with a personal event icon and database events with a database event icon. In the calendar view, any date on the calendar on which a selected event takes place includes a marker, wherein the marker for personal events differs from that for database events. The user can set preferences to select different colour markers for different genres such as ‘home’ ‘work’ ‘family’. When the user hovers over the marker a modal window appears showing the event detail.

The user interface is operable to present to a user a modal entry window for entering details of a personal event for populating the diary. The user can upload an image and/or video to accompany their entry. They can opt to list their entry on their other social network sites. The database will present other events to the user based on keywords that may appear in the users data, such as same location events nearby; events that have the same meaning. For example if the user inputs a diary event such as ‘drum lesson’ and then the address, the database will return listing for drum shops in that area . . . or perhaps a famous drummer is doing a book signing in the area . . . or there's a drum seminar. User input data relates directly to the events database and works in tandem to present relevant information to the user.

Event data is returned based on user personalisation and algorithm-detected preferences, resulting in relevant discovery and listing. The database and algorithms serve to display data ranked in what it believes the user wishes to see. Resulting information also determines the exact advert to be shown alongside any event as well as relevant discount vouchers, which relate either to the event and/or a similar category of product. For example, if the user is returned with an event ‘Disney On Ice’ at Wembley Arena; then it is likely they will see an advert for EuroDisney as well as a discount voucher for the Disney Store or to the cinema to see a new Disney film. All data can be added to the user's diary with clicking ‘+’.

The user can select to view or hide any number of categories or sub categories. Furthermore they can ‘drag’ each category window into the order they wish to view them from top of page to bottom. The selection of category forms part of the basis of future events displayed to the user. For example, if the user selects the category of premiership football and selects to add the entire premiership schedule into the calendar/diary, then the database remembers this selection and will constantly update the data entries in the calendar, push notify of any changes, and auto update the calendar year on year without further user interaction, thereby negating the need to select categories in the future.

Geo-location can be selected in user preferences allowing the user to, by default, view nearest events.

The database stores a type of events with a preference tag, the preference tag ensuring the return of the event responsive to a request if it meets the category and date criteria in the request, but regardless of other search parameters. The user may select any tag in order to view other related events.

The user can opt to display ‘events they've clicked on previously’ as a permanent feature thereby negating the need for a user to act proactively to see such data.

Search is predictive and is recognised as vertical search, search solely from the database. The search field recognises the characters instantly to when the user starts typing and immediately predicts potential events to negate the user having to type extensively. For example if the user types “GE . . . ” a modal window will open to display all “GE” events in the database starting with what the algorithm tells it is most likely to be what the user is looking for. In other words the user will see “GEORGE MICHAEL IN LONDON” “GEORGE HARRISON ANTHOLOGY RELEASE DATE” etc. When the user sees an exact match he may select that to see solely one event. This is ultimate refinement. User may prefer a more open search for “George” with the result being all ‘george’ events.

When an event is automatically updated the user will receive a push notification. All of the user's devices and systems will update under the same login. Whereby an event is updated and that update causes a clash with another diary entry the user will need to accept (in the push notification) which event should take preference.

An application programming interface (API), comprises program code arranged to receive information defining an event from an event source and to transform the event information into event data in a format suitable for loading into an event database. Other website developers will be able to use this API to easily adapt their websites to work with the database. For example a school would integrate the API in their website design so that when they enter their term schedule, their site displays the data for one-click entry into the diary.

Other functionality includes
INSTANT CHAT.
A user sees an event they like they can click on a chat button . . . select the friend they'd like to chat with . . . and discuss the event with them, whereby they can both then add the event into diary.
MICRO SITES.
Similar to the author pages for open access. In this instance companies have all their events in one address. For example “Daybees.com/Disney” to find all Disney events, with everything one-clickable into diary.

1.-39. (canceled)

40. A computer system for managing event data comprising:
a database configured to store event data relating to a plurality of events, each event associated with an event date; and
at least one processing device configured to execute a set of instructions for:
a handling function configured to receive a request from a user terminal, the request including at least a user identifier, a date, and a search refinement criteria;
a filter function configured to return event information corresponding to the date in the request, the filter function filtering the event data based on characteristics associated with the user identifier, wherein the filter function is operable to filter the plurality of events based on a history of the plurality of events selected by a user making the request; and
wherein the handling function is configured to supply the request to the filter function for accessing the database, the filter function configured to return events of the plurality of events based on the user identifier and any search parameters supplied in the request, and to return the events based on the user identifier where no search parameters are supplied in the request.

41. The computer system according to claim 40, the set of instructions comprising a search function configured to receive search parameters from the user terminal in the request and returning the event information from the event data corresponding to the search parameters.

42. The computer system according to claim 41, wherein the search parameters include a keyword, word or phrase to locate the events.

43. The computer system according to claim 40, wherein the filter function is operable to filter the plurality of events based on history by computing event-to-event similarity of at least one event selected in the past by the user and a candidate event for returning to the user.

44. The computer system according to claim 40, wherein the search function is operable to search the plurality of events based on the similarity of content in the event data to a keyword, word or phrase supplied by the user, wherein the filter function is operable to return a set of events grouped by a common parameter.

45. The computer system according to claim 40, wherein the filter function is arranged to filter the event data based on user preferences prior to returning the event information responsive to the request, wherein the user preferences are selected from a group consisting of:
most popular;
top ten; and
recently added.

46. The computer system according to claim 40, wherein the event data in the database includes the event information associated with a respective category identifier, the filter function filtering the event data based on categories associated with said characteristics; and
wherein the event data in the database is stored in association with a location identifier identifying the location of the event, the filter function filtering the event data based on a location identifier in the request.

47. The computer system according claim 40, wherein the database is configured to store a type of events with a preference tag, the preference tag ensuring the return of the event responsive to a request if it meets the category and date criteria in the request, regardless of other search parameters.

48. The computer system according to claim 40, wherein the database is configured to receive the event data from:
at least one crawler service; and
directly from at least one event supplier.

49. The computer system according to claim 40, the set of instructions comprising a diary function configured to receive data from the event selected by the user and to update a diary of the user based on the event data.

50. The computer system according to claim 40, further comprising:
the user terminal including a user interface configured to present returned event information to the user.

51. The computer system according to claim 40, the set of instructions comprising:
a push notification configured to transmit a push notification message to a user terminal identifying events in a user diary or events of possible interest to the user at the user terminal; and
a clash event notification configured to issue a warning to the user on an attempt to update a diary with an event which clashes with an existing event in the diary.

52. The computer system according to claim 49, the set of instructions comprising:
an update function configured to detect changes in the event data stored in an event database and to generate a diary update message to automatically update the diary with the changed event data, wherein the changed event data is associated with an event in the user diary, or relates to a class of events preselected by the user, wherein the changed event data is associated with a new event in the class of events and populates the diary with the new event.

53. The computer system according to claim 40, wherein the database is configured to receive the event data from an open diary having an author, and wherein the characteristics include at least one author identified by the user.

54. A computer program product comprising program code means which when executed on a computer implement the following steps:
implementing a handler function to receive a request from a user terminal, the request including a user identifier and a date;
accessing an event database for event information associated with events;
implement a filter function to filter the event data based on characteristics associated with the user identifier to return event information corresponding to the date in the request after said filtering, wherein the filter function is operable to filter events based on a history of events selected by a user making the request; and
implementing a search function for receiving search parameters from the user terminal in the request and returning event information from event data corresponding to the search parameters;
wherein the handler function is configured to supply the request to the filter and search functions for accessing the database, the filter function operable to return events based on the user identifier and any search parameters supplied in the request, and to return events based on the user identifier where no search parameters are supplied in the request.

55. A user device configured to automatically populate a user diary, the device comprising:
a processor configured to execute a program including a set of instructions for:
generating a request identifying a date;
transmitting the request to an event database;
receiving from the event database event data corresponding to the selected date;
a user interface configured to present to a user event information based on the event data for the selected date so as to permit a user to select at least one event for populating the user diary, whereby selection of the event by the user automatically imports the event to the diary, by updating stored diary data, and the user interface configured to allow the user to enter a personal event into the diary, wherein the user interface is operable to display a calendar view to the user, wherein any date on the calendar on which a selected event takes place includes a marker, wherein the marker for personal events differs from that for database events.

56. The user device according to claim 55, the set of instructions comprising instructions to generate a request with a search parameter based on the personal event entered by the user.

57. The user device according to claim 55, the set of instructions comprising instructions to receive selection of a date or range of dates from the user, that date or range of dates being identified in the request, wherein in the calendar view, the user selects a date by activating a displayed date in the calendar.

58. The user device according to claim 55, comprising a location indicator configured to generate location information in the request which is transmitted to the database, whereby event information is returned only for events at the indicated location, wherein the location indicator comprises a user selectable icon on the user interface, or a location device for automatically determining the position of the user and generating the location indicator.

59. The user device according to claim 55, wherein the user interface is configured to display a map to the user indicating the location of an event, optionally based on the entered location data.
